(19) United States
(12) Patent Application Publication
(10) Pub. No.: US 2006/0012205 A1
(43) Pub. Date: Jan. 19, 2006

(54) AUTOMOTIVE STORAGE COMPARTMENT AND METHOD FOR MAKING THE SAME

(76) Inventors: Bogdan Radu, Dearborn, MI (US); Mark Heinze, Clarkston, MI (US); Alan G. Dry, Gross Point Woods, MI (US); Richard D. George, Rochester Hills, MI (US)

Correspondence Address: WOOD, HERRON & EVANS, LLP (LEAR), 2700 CAREW TOWER, 441 VINE STREET, CINCINNATI, OH, 45202, US

(21) Appl. No.: 10/710,497

(22) Filed: Jul. 15, 2004

(51) Int. Cl. B60R 7/04

(52) U.S. Cl. 296/37.13

(57) ABSTRACT

An automotive storage compartment comprises a compartment body defining a cavity and having an opening for accessing the cavity. The compartment body includes at least one connecting member integrally formed therein. The storage compartment further includes a cover having at least one connecting member integrally formed therein, the cover connecting member cooperating with the compartment body connecting member to moveably couple the cover to the compartment body. A two-shot molding process may be used to form the storage compartment, with the compartment body and body connecting member being formed in the first shot and the cover and cover connecting member being formed in the second shot so that the cover is pivotally coupled to the compartment body.

### FIELD OF THE INVENTION

The present invention pertains generally to automotive interiors and more particularly to storage compartments for automotive interiors.

### BACKGROUND OF THE INVENTION

It is known to provide automotive interiors with various trim assemblies to improve the aesthetic appearance of the automotive interior and for the comfort and convenience of vehicle occupants. Examples of these interior trim assemblies include the instrument panels, armrests, door trim panels and consoles. In many of these trim assemblies, various storage compartments are incorporated therein that allow the vehicle occupant to conveniently store one or more items, such as tissue, coins, maps and other items typically carried in a vehicle. In many cases, such as for storage compartments in door panels, it is desirable for the compartment to include a door or cover that overlies the opening and secures the items within the compartment. The cover is typically attached to the compartment and moveable, such as by a hinge mechanism, so that the articles in the compartment may be accessed. Moreover, the cover may have additional padding coupled thereto and provide an armrest for the door panel.

While being desired by car owners and vehicle occupants, covered storage compartments have some drawbacks. The primary drawback is in the manufacturing and assembly of the various parts that make up the storage compartment. The current process for making a storage compartment is typically to form the compartment body in a first mold. The compartment door is then individually formed in a second and separate mold. A further separate connecting member, usually being a pair of metal or plastic cylindrical hinge pins, is then used to couple the compartment door to the compartment body. Moreover, current storage compartments typically include a pair of damping mechanisms to provide some resistance to opening and closing the door to the storage compartment. The as-formed storage compartment may then be inserted into the various trim assemblies in the automobile.

Thus, under current manufacturing processes, storage compartments comprise several different parts each having different part numbers that must all be appropriately supplied, tracked, shipped, inventoried and eventually assembled to make the complete product, such as a door panel or console. Multiple part assemblies in turn lead to significant administrative costs and labor costs, which increase the overall costs of production.

There is a need for an improved automotive storage compartment and a method for making the storage compartment that reduces the number of parts and reduces the labor required for assembly thereof, thereby reducing overall manufacturing costs.

### SUMMARY OF INVENTION

The present invention provides for an improved automotive storage compartment having a reduced number of parts and that is adapted to be coupled to an interior trim assembly, such as a door panel, of a vehicle.

To this end, the storage compartment includes a first member, which is either a compartment body or cover, having at least one connecting member integrally formed therein and made from a first material. The storage compartment further includes a second member, which is the other of the compartment body or cover, having at least one connecting member integrally formed therein and made from a second material different from the first material. The first and second materials may include various thermoplastic materials with one of the materials having a higher melting point than the other. The at least one connecting member on the first member includes at least one projecting portion and the at least one connecting member on the second member includes at least one receiving portion that receives the at least one projecting portion. The compartment body defines a cavity having an opening adapted to store one or more items such as coins, tissue and the like. The projecting and receiving portions accordingly are pivotally coupled together so that the storage compartment cover may be opened and closed to allow access to the cavity.

In an exemplary embodiment, the storage compartment includes a compartment body defining a cavity having an opening and adapted to store one or more items. The compartment body further includes an integrated pair of spaced apart connecting members with each having a projecting portion extending therefrom. Each projecting portion defines a pin having an enlarged distal end configured as a circular portion. The cover similarly includes an integrated connecting member having a pair of spaced apart receiving portions with each defining a bore having an enlarged portion configured as a circular recess. Each circular recess receives one of the circular portions to couple the cover to the compartment body such that the cover is pivotally moveable between an open position, wherein the cavity is accessible through the opening, and a closed position, wherein the cover overlies the opening. The compartment body may be formed from polybutylene terephthalate or polyamide 12. The cover may be formed from polypropylene, polyoxymethylene or polyamide 6.

The automotive storage compartment may be formed by a two shot molding operation. In a first shot of the molding operation, the first material is injected into a mold to form the first member, i.e. the compartment body or cover, having the at least one integrated connecting member that includes the at least one projecting portion extending therefrom. Next, a mold chamber is formed about at least a portion of the first member, and more specifically, about a portion of the at least one projecting portion. After the first shot, the second material is injected into the mold chamber in a second shot of the molding operation to form the second member, i.e. the other of the body or cover, having the at least one integrated connecting member that includes the at least one receiving portion. The second material has a lower melting point than the first material to avoid fusion of the receiving portion to the projection portion. Accordingly, the at least one receiving portion overmolds the at least one projecting portion so that the compartment body and cover are pivotally coupled together. The storage compartment may then be incorporated into an automotive trim assembly, such as a door panel.

By virtue of the foregoing, there is thus provided an improved automotive storage compartment having a reduced number of parts and that is adapted to be coupled to an interior trim assembly of a vehicle.

The features and objectives of the present invention will become more readily apparent from the following Detailed Description taken in conjunction with the accompanying drawings.

### BRIEF DESCRIPTION OF DRAWINGS

The accompanying drawings, which are incorporated in and constitute a part of this specification, illustrate embodiments of the invention and, together with a general description of the invention given above, and the detailed description given below, serve to explain the invention.

FIG. 1 is a side perspective view of an automotive trim assembly including an embodiment of the storage compartment of the present invention in the form of a door panel;

FIG. 2 is a top plan view of the trim assembly of FIG. 1 showing a cut-away portion of the storage compartment to illustrate the coupling between the cover and compartment body;

FIG. 2A is an enlarged view of the incircle portion 2A showing the coupling between the cover and compartment body of FIG. 2;

FIG. 2B is a figure similar to 2A showing another embodiment of the present invention;

FIG. 3 is a perspective view of a mold used to form the compartment body of the storage compartment of the present invention;

FIG. 3A is the first in a series of sequential cross-sectional views of the mold of FIG. 3 taken along the lines 3A-3A illustrating the first shot of the molding operation of the storage compartment; FIG. 3B is the second in this series of cross-sectional views;

FIG. 4 is a perspective view of a mold used to form the cover of the storage compartment;

FIG. 4A is the first in a series of sequential cross-sectional views of the mold of FIG. 4 taken along the lines 4A-4A illustrating the second shot of the molding operation of the storage compartment; FIG. 4B is the second in this series of cross-sectional views; and

FIG. 5 is a cross-sectional view of the storage compartment of FIG. 4B removed from the mold and showing the cover in an open and closed position.

### DETAILED DESCRIPTION

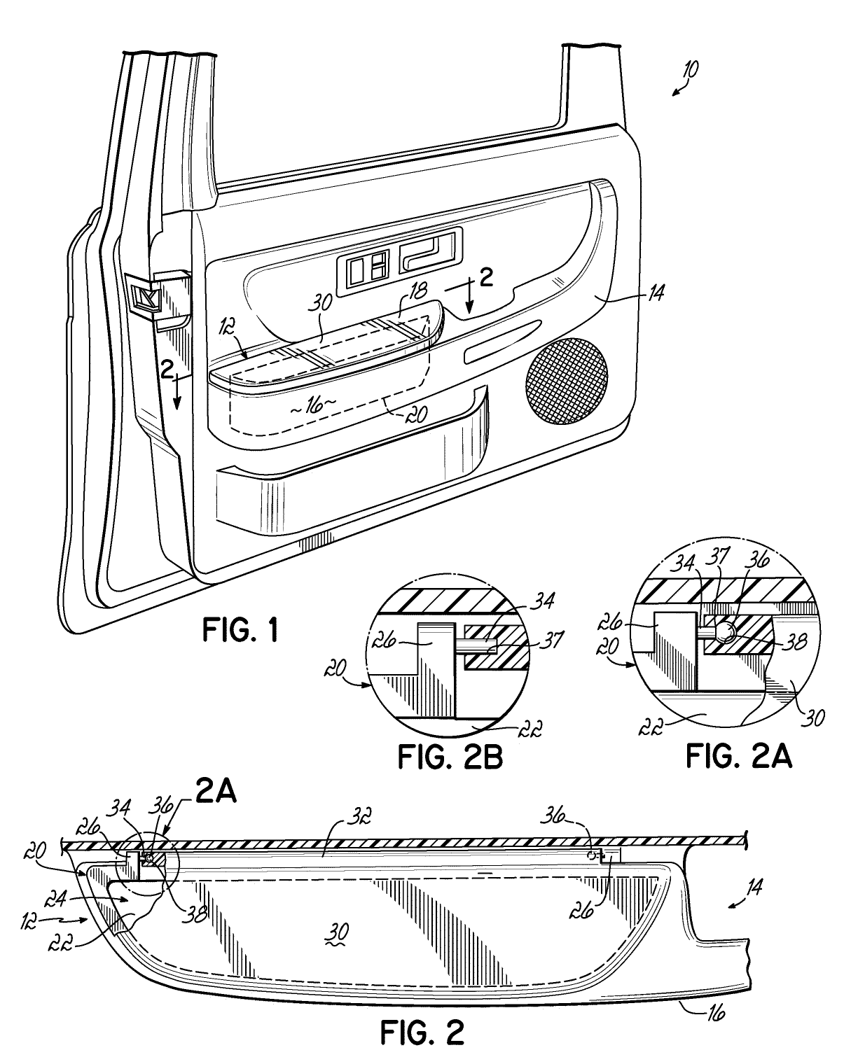

In FIG. 1, there is shown an interior trim assembly, in the form of a door panel 10 for an automobile (not shown), including an embodiment of the automotive storage compartment 12 of the present invention within a substrate 14 of door panel 10. The door panel 10 covers a portion of the interior of the automobile door to provide a more aesthetically pleasing environment, as well as additional comfort to the vehicle's occupants. Other various trim assemblies in the automobile, such as instrument panels, rear passenger side panels and consoles, are generally constructed in a similar fashion and may benefit from the present invention. Thus, while the following detailed description focuses on the storage compartment 12 being included in a door panel 10, those having ordinary skill in the art will recognize that the storage compartment 12 may equally be incorporated in other automotive trim assemblies.

With further reference to FIGS. 1 and 2, the door panel 10 includes a relatively rigid substrate 14, which receives the storage compartment 12 and which forms at least a portion of the structural support and defines the general shape of the door panel 10. The door panel 10 may be secured to the interior of the automobile, for example, by a bracket or mounting member (not shown) as is known in the art. The door panel 10 further includes a front surface 16 that faces the interior of the automobile and a back surface (not shown) opposite the front surface 16 that is hidden from view when the panel assembly 10 is mounted to the automobile. As shown in FIG. 1, storage compartment 12 may be incorporated into door panel 10 and cooperate with other features, such as armrest 18, to hide the storage compartment 12 from view.

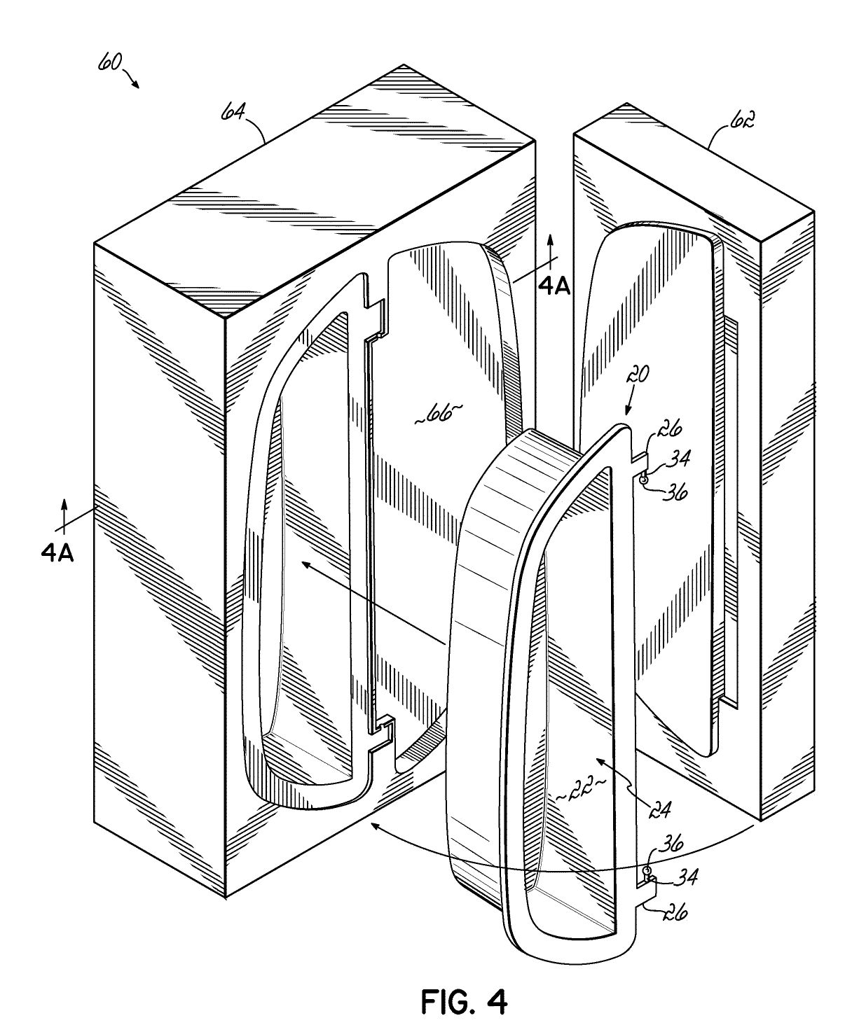

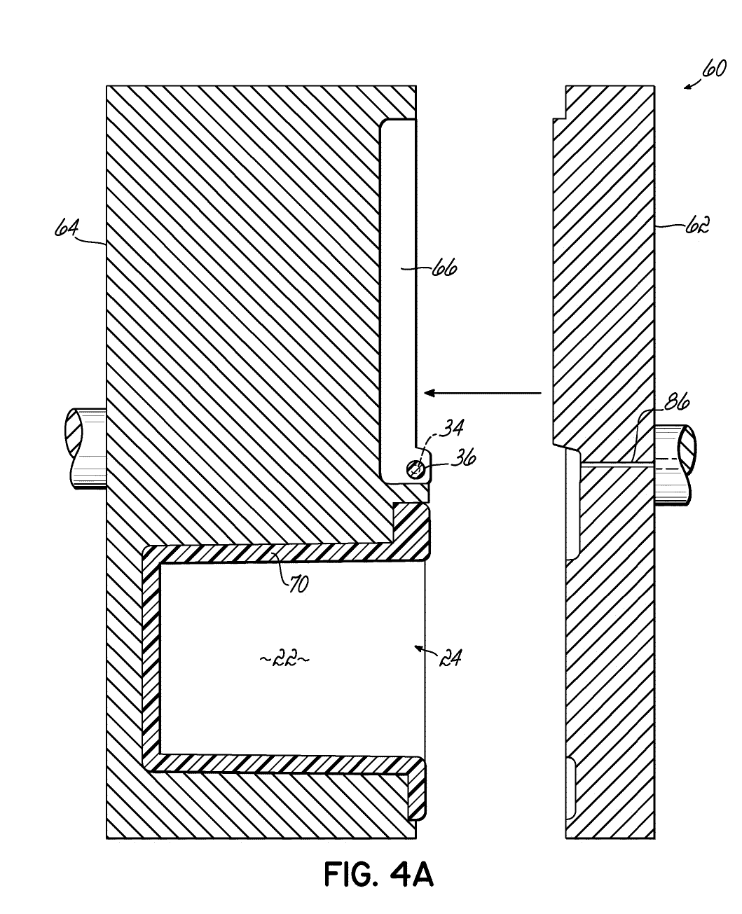

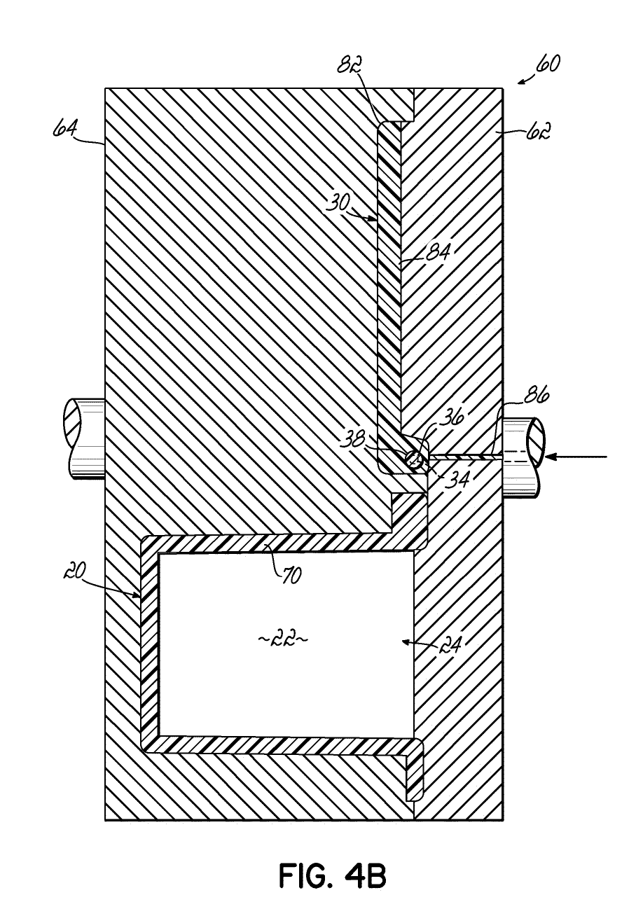

As best shown in FIGS. 2-2A and 4, the storage compartment 12 includes a compartment body 20 defining a cavity 22 having an opening 24 for gaining access to the cavity 22. The cavity 22 is adapted to store one or more items such as coins, tissue, maps and the like. The compartment body 20 further includes a pair of spaced apart connecting members 26 integrally formed therein. While two connecting members 26 are shown in FIGS. 2 and 4, it should be understood by those of ordinary skill in the art that one connecting member or more than two connecting members may be integrally formed with the compartment body 20. The compartment body 20 is made of a thermoplastic material such as a thermoplastic synthetic resin. For example, the compartment body may be formed from polybutylene terephthalate or polyamide 12.

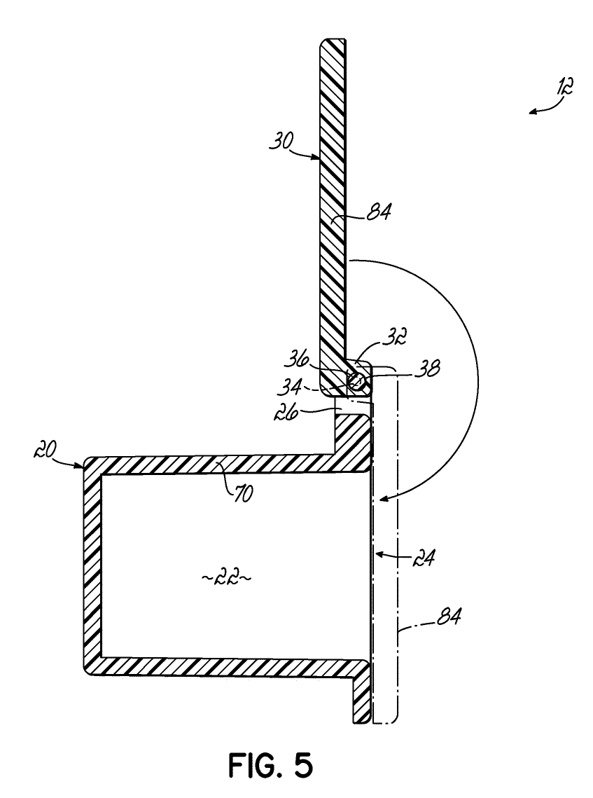

As best shown in FIGS. 2 and 5, the storage compartment 12 also has a cover 30 including one connecting member 32 integrally formed therein. It similarly should be understood by those having ordinary skill in the art that more than one connecting member 32 may be integrally formed with the cover 30. The cover 30 is made of a thermoplastic material such as a thermoplastic synthetic resin. For example, the cover may be formed from polypropylene, polyoxymethylene, or polyamide 6, and further has a different melting point from the material of the body 20. Advantageously, the cover material has a lower melting point than the compartment body material.

With further reference to FIGS. 2-2A, each integral connecting member 26 of the body 20 includes a projecting portion defining a pin 34 having an enlarged distal end configured as a circular portion 36. The integral connecting member 32 of the cover 30 includes a pair of spaced apart receiving portions defining a bore 37 having an enlarged receiving portion configured as a circular recess 38. Accordingly, the connecting members 26 of the body 20 cooperate with the connecting member 32 of the cover 30 to couple the cover 30 to the compartment body 20, and more specifically, each circular recess 38 receives one of the circular portions 36 to pivotally couple the cover 30 to the compartment body 20 such that the cover 30 is moveable, as shown in FIG. 5, between an open position, wherein the cavity 22 is accessible through the opening 24, and a closed position, wherein the cover 30 overlies the opening 24.

It should be understood that the projecting portions 34 and receiving portions 37 can comprise any multitude of desired shapes and sizes for pivotally coupling together the body 20 and cover 30. By way of example, FIG. 2B shows another embodiment of the storage compartment 12 wherein the pin 34 is devoid of the circular portion 36 while the corresponding bore 37 similarly is devoid of the circular recess 38. Accordingly, the bore 37 receives the pin 34 to pivotally couple the cover 30 to the compartment body 20. It also should be understood that the body connecting members 26 may include more than one projecting portion 34 and the cover connecting member 32 may include any number of corresponding receiving portions 37. It is further understood that the cover 30, alternatively, could be provided with one or more projecting portions 34 while the compartment body 20, alternatively, could be provided with one or more integrated receiving portions 37.

The storage compartment 12 may further include one or more hinge springs (not shown) cooperating with the body 20 and the cover 30 to assist with movement of the cover 30 from the open position to the closed position.

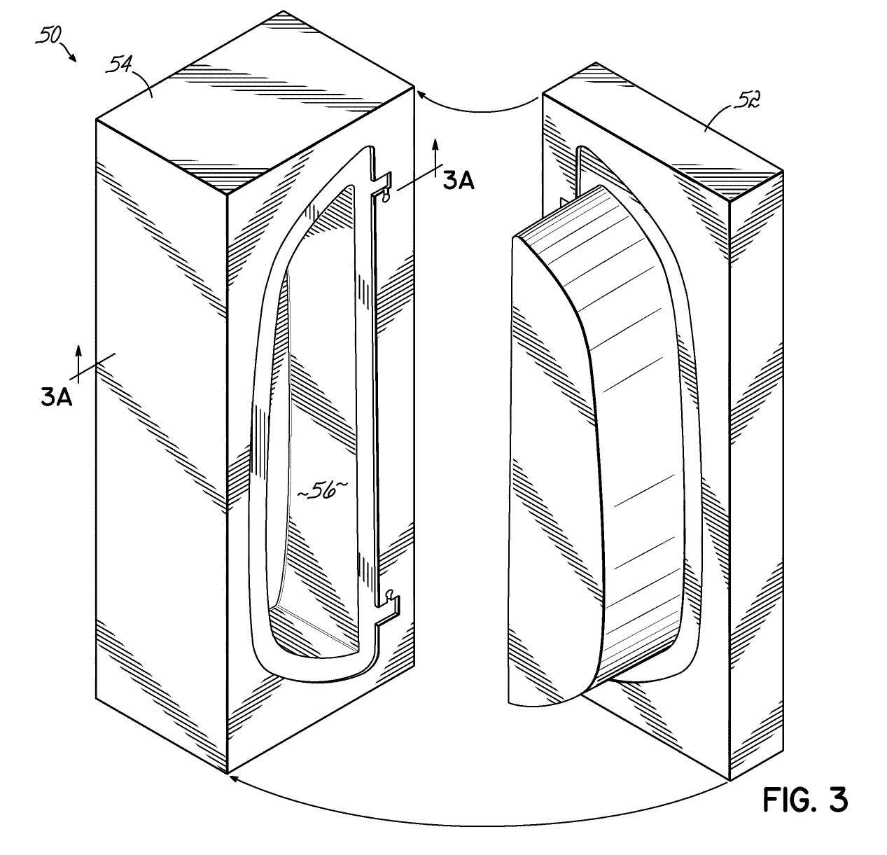

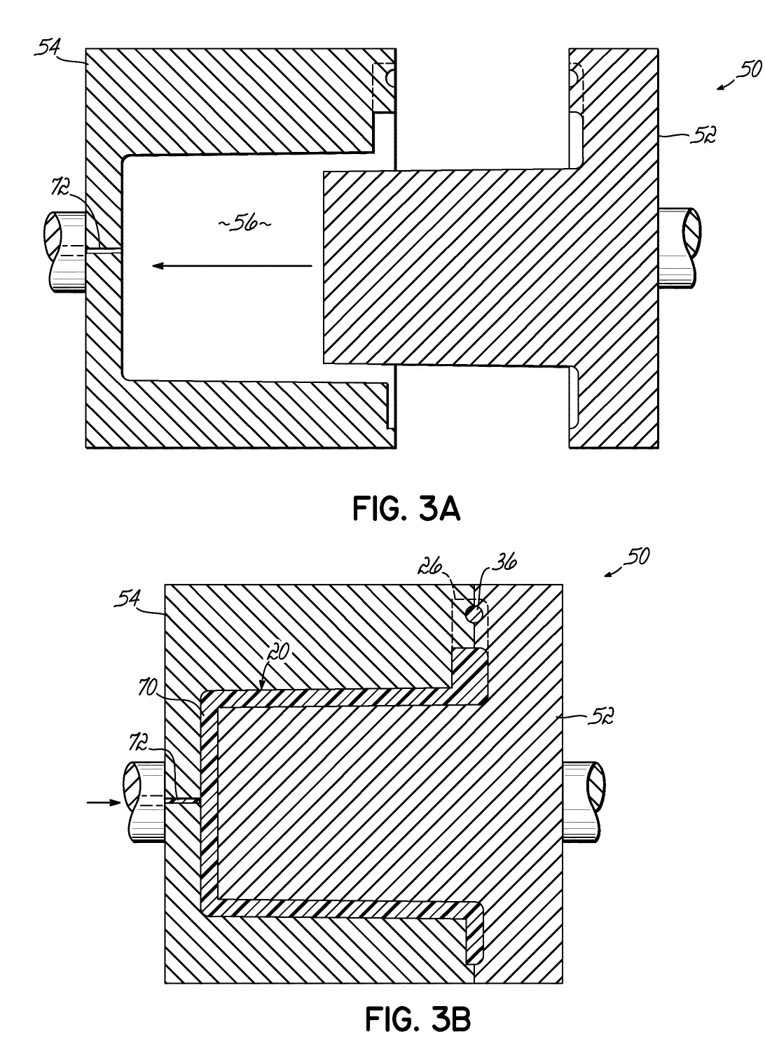

With reference to FIGS. 3-5, a method of making the storage compartment 12 of the present invention will now be described. More specifically, the storage compartment 12 is formed by a two-shot molding operation wherein a first shot molds one of either the compartment body 20 or the cover 30, and wherein a second shot molds the other of the body 20 or cover 30 to couple the parts together. To this end, and as shown in FIG. 3, a first mold 50 is shown including a top portion 52 and a bottom portion 54 defining a first cavity 56 adapted to mold a first member, i.e. the compartment body 20, in a first shot. In FIG. 4, a second mold 60 is shown including a top portion 62 and bottom portion 64 defining a cavity 66 adapted to mold a second member, i.e. the cover 30, in a second shot. While the first and second molds 50, 60 are illustrated separately, it should be understood that the first and second molds 50, 60 may be provided together in a single mold assembly as is well known in the art.

As best shown in FIGS. 3A and 3B, to mold the compartment body 20, the first mold 50 is closed and a first curable material 70 is injected through a channel 72, in a first shot, into the space formed between the top and bottom portions 52, 54. The first curable material 70 advantageously is a thermoplastic material such as polybutylene terephthalate and polyamide 12. The injected material 70 is allowed sufficient time to at least partially cure to form the compartment body 20.

As best shown in FIGS. 3B and 4, the molded body 20 defines the cavity 22 having the opening 24 for gaining access thereto. This cavity 22 is adapted to store one or more items such as coins, tissue, maps and the like. The compartment body 20 further includes the pair of integrally formed, spaced apart connecting members 26 with each having the projecting portion extending therefrom defining the pin 34 having the enlarged distal end configured as the circular portion 36.

With further reference to FIG. 4, after the body 20 is molded in FIG. 3B, the body 20 is moved to the second mold 60. Movement of the body 20 to the second mold 60 can occur by methods commonly known in the art such as by hand, i.e. manually, by robotic means, or by utilizing a rotating mold assembly. With respect to the rotating mold assembly (not shown), the first member, e.g. the body, may be formed in a first mold as stated above. The mold is then opened and the first member, rather than being manually or robotically moved, is rotated, e.g. 180 degrees, on a rotating platen to coordinate with a second mold to form the second member, e.g. the cover. The rotating mold assembly advantageously allows for simultaneous molding of first and second members.

As best shown in FIGS. 4A and 4B, after the body 20 has been moved to the second mold 60, a portion of the connecting members 26, and more specifically, a portion of the projecting portions 34 are received within the cavity 66 of the second mold 60 that is adapted to mold the cover 30. Notably, the second mold 60 is closed to form a mold chamber 82 about a portion of the projecting portions 34. A second curable material 84 is then injected through a channel 86, in a second shot, into the space, i.e. the mold chamber 82, formed between the top and bottom portions 62, 64. This second curable material 84 has a lower melting point than the first curable material 70. Accordingly, the second material 84 is provided at a lower temperature than the melting point of the first material 70 so as to avoid fusion of the circular recess 38 to the circular portion 36. The second material 84 advantageously is a thermoplastic material such as polypropylene, polyoxymethylene, polyamide 6 or other suitable materials.

As further shown in FIGS. 4B and 5, the injected material 84 is allowed sufficient time to cure to form the cover 30 at a position 180 degrees relative to the body 20. After the storage compartment 12 is formed, the mold 60 may be opened and the storage compartment 12 ejected therefrom. Accordingly, the cover 30 includes the integrally formed connecting member 32 including the pair of spaced apart receiving portions defining the bore 37. Each bore 37 has the enlarged receiving end defining the circular recess 38 overmolding the circular portions 36 so that the compartment body 20 and cover 30 are pivotally coupled together. As best shown in FIG. 5, the cover 30 of the formed storage compartment 12 is moveable between the open position, wherein the cavity 22 is accessible through the opening 24, and the closed position, wherein the cover 30 overlies the opening 24. Notably, the first and/or second curable materials 70, 84 further may be selected based upon a desired shrinkage property to provide for varying degrees of friction between the projecting portions 34 and receiving portions 37 to alter the ease with which the cover 30 may be opened and closed.

One or more hinge springs (not shown) further may be provided to cooperate with the body 20 and the cover 30 to assist with movement of the cover 30 from the open position to the closed position.

Advantageously, the molding operation of the present invention may be continuously performed utilizing a single mold assembly to provide an improved automotive storage compartment. The molded storage compartment 12, as shown in FIG. 1, may now be received within substrate 14 of the door panel 10. It should be recognized that additional manufacturing operations may be performed on storage compartment 12. For example a foam pad may be coupled to the top surface of cover 30 so that cover 30 further performs as an armrest 18 for door panel 10. Those having ordinary skill in the art will recognize that the storage compartment 12 may equally be included in the substrates of other automotive trim assemblies, e.g. instrument trim panels, rear passenger side panels, center consoles and others.

Although the above method has described molding the first member as the body 20 and molding the second member as the cover 30, it should be understood that the cover 30, alternatively, could be molded as the first member while the compartment body 20, alternatively, could be molded as the second member. It is further understood that the receiving portions 37, alternatively, may be formed with the first member while the projecting portions 34 alternatively may be formed with the second member.

While the present invention has been illustrated by the description of the various embodiments thereof, and while the embodiments have been described in considerable detail, it is not intended to restrict or in any way limit the scope of the appended claims to such detail. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope or spirit of Applicants' general inventive concept.

What is claimed is:

1. An automotive interior trim assembly, comprising:
a substrate; and
a storage compartment coupled to said substrate and adapted to store one or more items, said storage compartment comprising:
a compartment body defining a cavity adapted to store the one or more items and having an opening for gaining access to said cavity, said compartment body including at least one connecting member integrally formed therein made from a first material; and
a cover including at least one connecting member integrally formed therein and made from a second material having a different melting point from said first material, said at least one body connecting member cooperating with said at least one cover connecting member to couple said cover to said compartment body, said cover being moveable between an open position, wherein said cavity is accessible through said opening, and a closed position, wherein said cover overlies said opening.

2. The trim assembly of claim 1, wherein said at least one body connecting member comprises at least one projecting portion extending therefrom, and wherein said at least one cover connecting member comprises at least one receiving portion therein which receives said at least one projecting portion.

3. The trim assembly of claim 2, wherein said at least one projecting portion defines a pin.

4. The trim assembly of claim 2, wherein said at least one receiving portion defines a bore.

5. The trim assembly of claim 1, wherein said at least one body connecting member includes a pair of spaced apart connecting members, each said connecting member having at least one projecting portion defining a pin having an enlarged distal end configured as a circular portion, and wherein said at least one cover connecting member includes one connecting member, said cover connecting member including a pair of spaced apart receiving portions, each receiving portion defining a bore having an enlarged receiving portion configured a circular recess, each said circular recess receiving one of said circular portions to couple said cover to said compartment body.

6. The trim assembly of claim 1, wherein said cover is pivotally movable between said open and closed position.

7. The trim assembly of claim 1, wherein said first material is selected from the group consisting of polybutylene terephthalate and polyamide 12 and said second material is selected from the group consisting of polypropylene, polyoxymethylene or polyamide 6.

8. The trim assembly of claim 1, wherein said first material has a higher melting point than said second material.

9. The trim assembly of claim 1 configured as a door panel.

10. A method of forming an automotive storage compartment in a two-shot molding operation, comprising:
molding a first member as one of a compartment body and a cover having at least one connecting member by injecting a first curable material in a first shot of the molding operation;
forming a mold chamber about a portion of the at least one connecting member; and
molding a second member as the other one of the compartment body and the cover having at least one connecting member by injecting into the mold chamber a second curable material in a second shot of the molding operation, the second member being molded so that the at least one first member connecting member and the at least one second member connecting member are pivotally coupled together.

11. The method of claim 10, wherein molding the first member comprises molding the compartment body having the at least one connecting member, and wherein molding the second member comprises molding the cover having the at least one connecting member.

12. The method of claim 11, wherein the at least one body connecting member includes at least one projecting portion extending therefrom, and wherein the at least one cover connecting member includes at least one receiving portion therein, the at least one receiving portion molded around the at least one projecting portion so that the at least one body connecting member and the at least one cover connecting member are pivotally coupled together.

13. The method of claim 12, wherein the at least one projecting portion defines a pin.

14. The method of claim 12, wherein the at least one receiving portion defines a bore.

15. The method of claim 10, wherein molding the first member comprises molding the compartment body having a pair of spaced apart connecting members, each of the body connecting members having at least one projecting portion defining a pin having an enlarged distal end configured as a circular portion, and wherein molding the second member comprises molding the cover having one connecting member including a pair of spaced apart receiving portions, each receiving portion defining a bore having an enlarged receiving portion configured as a circular recess, each circular recess molded around one of the circular portions to pivotally couple the compartment body to the cover.

16. The method of claim 10, wherein the first curable material has a higher melting point than the second curable material.

17. The method of claim 10, wherein the first curable material is selected from the group consisting of polybutylene terephthalate and polyamide 12, and said second material is selected from the group consisting of polypropylene, polyoxymethylene or polyamide 6.

18. An assembly for an automotive interior, comprising:
a first member including at least one connecting member integrally formed therein made from a first material; and
a second member including at least one connecting member integrally formed therein and made from a second material having a different melting point from said first material, said at least one first member connecting member cooperating with said at least one second member connecting member to pivotally couple said first member to said second member.

19. The assembly of claim 18, wherein said first member comprises a compartment body and said second member comprises a cover.

20. A method of forming an assembly for an automotive interior in a two-shot molding operation, comprising:
molding a first member having at least one connecting member by injecting a first curable material in a first shot of the molding operation;
forming a mold chamber about a portion of the at least one connecting member; and
molding a second member having at least one connecting member by injecting into the mold chamber a second curable material in a second shot of the molding operation, the second member being molded so that the at least one first member connecting member and the at least one second member connecting member are pivotally coupled together.
